(19) United States
(12) Patent Application Publication
(10) Pub. No.: US 2026/0064659 A1
(43) Pub. Date: Mar. 5, 2026

(54) RULES ENGINE FOR AUTOMATIC MAA REVIEWS

(71) Applicant: Oracle International Corporation, Redwood Shores, CA (US)

(72) Inventors: Aiman Al-Khammash, Monument, CO (US); Lawrence To, Belmont, CA (US); Holger Leister, Königstein im Taunus (DE); Javier Arellano Alameda, Madrid (ES); Liliana Adriana Neghiu, Otopeni (RO); Prakash Venkatraman, Bangalore (IN); Catalin Cristu, Bucharest (RO); Michael David Nowak, Hackettstown, NJ (US); Michael Todd Smith, Brentwood, TN (US)

(21) Appl. No.: 18/825,311

(22) Filed: Sep. 5, 2024

(51) Int. Cl. G06F 16/23; G06F 16/21

(52) U.S. Cl. CPC G06F 16/2365; G06F 16/213

(57) ABSTRACT

For reliability, availability, and serviceability (RAS) of a database, here are novel performance optimization rules that generate a configuration of a new database or an improved configuration of an existing database. These rules perform a service level agreement (SLA) assessment to detect which database architecture options are needed. The rules recommend improvements to the database's current architecture so that recovery time objectives (RTO) and recovery point objectives (RPO) can be achieved by non-expert technicians. The rules analyze database diagnostics from health monitoring, diagnostic logs, persistent and network storage statistics, database performance statistics, and operating system (OS) statistics. The rules may analyze a database configuration that contains an interactively completed questionnaire or a diagnostic report generated by database infrastructure. The rules can be used speculatively to predict the RAS performance characteristics of an unimplemented configuration or used remedially to generate suggestions for improving RAS performance of a deployed configuration.

### FIELD OF THE DISCLOSURE

This disclosure relates to reliability, availability, and serviceability (RAS) of a database. Novel performance optimization rules generate a configuration of a new database or an improved configuration of an existing database.

### BACKGROUND

Cloud hosting may be motivated by technologic concerns of reliability, availability, and serviceability (RAS) that may place technical demands on configuration and resource allocation of a database. In a public cloud, the customer owns and administers the database but might not have the software system engineering expertise needed to optimize the performance of the database. For example, the public cloud or the database infrastructure may have proprietary configuration settings that the customer may adjust.

Even if the customer is fully proficient at configuring the database for the public cloud, it may be difficult or impossible for the customer alone to predict how well will chosen configuration settings actually perform in production. For example, recreation of a similar workload may be difficult or impossible in a testing laboratory, and the infrastructure performance characteristics are unlikely to be similar between test and production.

As a result of those complications, the customer might be unable to answer some important performance questions regarding database stability and the impact of crash recovery on aspects such as outage duration and permanent data loss. Not only is optimal database performance unlikely, but it also may be very difficult for state of the art cloud diagnostics to reveal whether or not a database is optimally configured. These problems may be intensified if the customer is unaware of best administration practices for the particular public cloud. Here, best practices may be practices required to achieve RAS. In that case, compliance is not optional but also, in a state of the art public cloud, unenforced. Even if the customer is fully aware of required practices, a state of the art public cloud does not verify compliance and does not suggest how to achieve compliance, and a customer might be unaware of noncompliance or uncertain about how to achieve compliance.

For example, if the customer has state of the art diagnostic output that is inconsistent, cryptic, or incomplete, then the customer can neither optimize the database nor predict RAS problems. For example, diagnostic output or configuration settings may require infrastructure expertise to interpret. Few technicians have experience in all areas of RAS such as high availability, data replication and synchronization, disaster recovery, and horizontal scaling and elasticity. These many complications of public clouds may, for example, limit cloud adoption.

### BRIEF DESCRIPTION OF THE DRAWINGS

In the drawings:

FIG. 1 is a block diagram that depicts an example computer that interprets novel performance optimization rules to generate a configuration of a new database or an improved configuration of an existing database;

FIG. 2 is a flow diagram that depicts an example computer process that interprets novel performance optimization rules to generate a configuration of a new database or an improved configuration of an existing database;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

For reliability, availability, and serviceability (RAS) of a database, here are novel performance optimization rules that generate a configuration of a new database or an improved configuration of an existing database. These rules perform a service level agreement (SLA) assessment to detect which database architecture options are needed. The rules recommend improvements to the database's current architecture so that recovery time objectives (RTO) and recovery point objectives (RPO) can be achieved by non-expert technicians.

The rules may generate a report such as an outage/repair matrix comparing current vs recommended database settings, which can be used to address technologic challenges such as a stale version of database software, a security vulnerability, data preservation, failover readiness, resource allocation, and capacity planning. The rules analyze database diagnostics from health monitoring, diagnostic logs, persistent and network storage statistics, database performance statistics, and operating system (OS) statistics.

Depending on scenarios herein, the rules may analyze a database configuration that contains either or both of an interactively completed questionnaire and a diagnostic report generated by database infrastructure. For a new database that awaits creation, the rules can generate an optimal configuration from only objectives and other preferences in the interactive questionnaire. Even without a questionnaire, the rules can analyze the configuration of an existing database, with or without an accompanying diagnostic report, and generate an improved configuration that should outperform the current configuration of the database. In those ways, the rules can be used speculatively to predict the RAS performance characteristics of an unimplemented configuration or used remedially to generate suggestions for improving RAS performance of a deployed configuration.

The rules generate a report that may be presented to the user for various purposes such as: a) an explanation of why a current configuration is incomplete, infeasible, or suboptimal, b) an explanation of why the generated improved configuration is better than the current configuration, or c) a recommendation or plan to configure the database as specified by the generated configuration. Because the user defines the RAS performance constraints, relative priorities, and objectives, the user can effectively establish custom success criteria. The rules may suggest adjustments in the generated report that may have automatically assigned urgencies and deadlines. For example, a user may select more urgent suggested adjustments without less urgent adjustments, and invoke the rules again to predict how much would RAS performance improve.

In an embodiment, the rules can be loaded, revised, and reloaded into a rules engine that maintains variables that a rule may write and another rule may read. In that cooperative way, rules may be effectively interconnected into a linear chain or a more complex arrangement. In an embodiment, a rule is created and maintained in an interactive graphical wizard that does not need programming expertise to use, and the rule is compiled into JavaScript for accelerated rule interpretation at runtime by the rules engine.

### 1.0 Example Computer

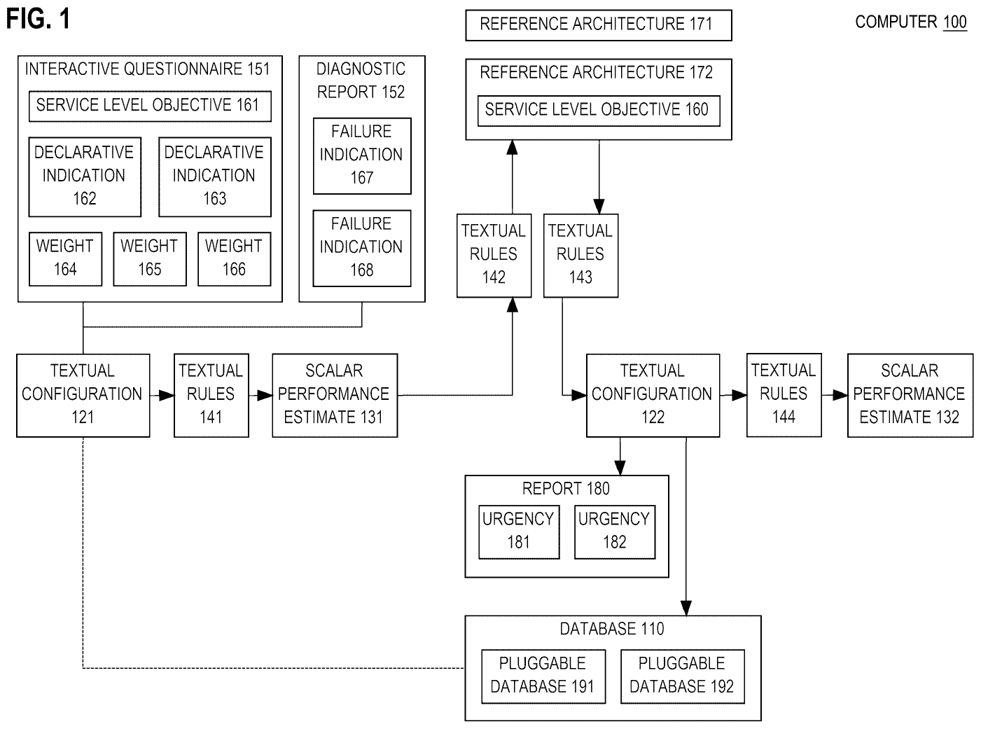

FIG. 1 is a block diagram that depicts example computer 100. For optimal reliability, availability, and serviceability (RAS), computer 100 interprets novel performance optimization rules to generate a configuration of a new database or an improved configuration of an existing database. Computer 100 may be one or more instances of a rack server such as a blade, a mainframe, a virtual machine, or other computing device.

In computer 100 or another computer, database 110 already exists or may later be created. Possibly excluding databases 110 and 191-192, all of the components shown in FIG. 1 may be stored and operated in random access memory (RAM) of computer 100. Database 110 may be an on-premise database, a database hosted in a datacenter, or a cloud database. Herein, a cloud database is hosted in a public or private cloud that may contain many computers. Database 110 may be integrated into database infrastructure such as a database server or a database management system (DBMS).

### 1.1 Database Configuration

Database 110 and its integrated infrastructure may be configured as specified in textual configuration 121 that is a text document that contains structured text such as JavaScript object notation (JSON), extensible markup language (XML), or a property file. Based on textual rules 141-144 as discussed later herein, computer 100 can analyze structured texts 121 and 151-152 and generate textual configuration 122 that also is structured text. In various embodiments discussed later herein, some or all of components 141-144, 171-172, and 180 may be structured texts.

In various embodiments not shown: a) database 110 is part of a software application that computer 100 contains, or b) database 110 is absent and a software application is used instead of database 110. In either (a) or (b), textual configuration 122 may contain configuration properties of the software application. For example, the software application may be hosted by a web server or an application server in computer 100.

Depending on scenarios discussed later herein, textual configuration 121 contains cither or both of interactive questionnaire 151 and diagnostic report 152. Three example scenarios are: 1) interactive questionnaire 151 is present and database 110 does not yet exist, 2) database 110 exists as precisely defined by textual configuration 121 and diagnostic report 152 is absent, and 3) database 110 exists and diagnostic report 152 is present. Database 110 and textual configuration 121 are shown connected by a dashed line to demonstrate that textual configuration 121 can exist regardless of whether database 110 does or does not exist.

### 1.2 Interpreted Rules

Interactive questionnaire 151 contains user-provided objectives and constraints that database 110 should satisfy. Diagnostic report 152 contains telemetry that characterizes the RAS performance of database 110. Specific data in interactive questionnaire 151 and in diagnostic report 152 are discussed later herein. In various scenarios discussed later herein, text rules 141-144 may detect that textual configuration 121 is infeasible or incomplete or suboptimal and generate textual configuration 122 that is complete, feasible, and optimal for database 110. In an embodiment, textual configurations 121-122 specify configuration settings of database 110 and configuration settings of the infrastructure that hosts database 110 such as any of a container database, a DBMS, a database server, an operating system, a virtual machine, and a physical computer. For example, database 110 may be a container database, a pluggable database, or a standalone database. Techniques for configuring pluggable and container databases are discussed later herein and in U.S. Pat. No. 9,239,763 “Container Database” filed Sep. 28, 2012 by Jacbock Lee et al, which is incorporated in its entirety herein.

Textual rules 141-144 are many formal rules encoded in text that computer 100 can interpret to analyze existing data and generate new data. In an embodiment, some textual rules are encoded as Turing-complete imperative JavaScript and some textual rules are encoded as Turing-incomplete declarative JSON that computer 100 can compile into imperative JavaScript. For example, computer 100 may receive a mix of JSON and JavaScript rules and, after rule compilation, interpret rules only as JavaScript.

A textual rule may define a condition that evaluates data and an action that will be performed when the condition is satisfied. For example, the condition may be a compound condition that is a composite of requisite or alternative conditions. An action may generate or modify data, which may cause conditions of other rules to become satisfied or unsatisfied. For example, an action of a first rule may write a variable that a condition of a second rule evaluates. In that way, rules may interact with each other and may, for example, cause a cascading sequence of actions of multiple rules to occur. In an embodiment, computer 100 contains a rules engine into which textual rules can be loaded or replaced, and the rules engine interprets the textual rules.

Because imperative JavaScript is Turing complete, a condition or an action may be specified as complex logic that may, for example, contain sequences of JavaScript statements, nest lexical blocks (i.e. lexical scopes), and invoke subroutines. Turing completeness means that JavaScript can implement any general purpose computation of any complexity. In an embodiment, a textual rule consists of a single JavaScript “if”′ statement that consists of a statement condition and a statement body that is a lexical block that may contain multiple statements. The statement condition may consist of the condition of the rule. The statement body may consist of the action of the rule.

A textual rule may evaluate multiple variables, write multiple variables, and cause conditions of multiple other rules to be satisfied. For example as shown, scalar performance estimate 131 may be a value that an action of one of textual rules 141 may generate and write, which textual rules 142 may read in conditions and actions.

### 1.3 Ras Performance Predicted by Rules

Scalar performance estimates 131-132 are inferences (i.e. not empirical observations) that characterize the reliability, availability, and serviceability (RAS) performance of a textual configuration of database 110. Herein, the performance of a textual configuration is the predictively estimated performance that database 110 should achieve if configured with the textual configuration. Scalar performance estimates 131-132 are comparable and have a same datatype that may be a number, a string literal, or a Boolean. From textual configuration 121, textual rules 141 may generate many scalar performance estimates of various datatypes and semantics as discussed later herein. From textual configuration 122, textual rules 144 may generate many scalar performance estimates of those various datatypes and semantics. In an embodiment, textual rules 141 and 144 are identical or partially overlapping sets of rules. For example, scalar performance estimates 131-132 may be generated by respective distinct evaluations of a same rule.

In a Boolean example, scalar performance estimate 131 may be a prediction that textual configuration 121 is unlikely to be feasible or that a particular objective is unlikely to be fulfilled, and scalar performance estimate 132 may be a prediction that textual configuration 122 is likely or guaranteed to be feasible or that the particular objective is likely or guaranteed to be fulfilled. In a numeric example, scalar performance estimate 131 may be a prediction that quantifies suboptimal RAS performance of textual configuration 121, and scalar performance estimate 132 may be a prediction that quantifies optimal or improved RAS performance of textual configuration 122. For example, scalar performance estimates 131-132 may be compared to predict that textual configuration 122 should outperform textual configuration 121 because scalar performance estimate 132 exceeds (i.e. is better than) scalar performance estimate 131. For example, scalar performance estimate 132 may be a lower recovery duration or a higher uptime duration than scalar performance estimate 131.

In an embodiment, scalar performance estimates 131-132 may be based on a count of pluggable databases 191-192 in database 110, and textual rules 141 may infer this count by analyzing textual configuration 121. For example, textual rules 141 may linearly scale a computer resource demand estimate as a dependent variable with the count of pluggable databases as the independent variable, and the scaled resource demand may decrease scalar performance estimate 131.

### 1.4 Diagnostic Telemetry Analyzed by Rules

A condition or action of a rule may read any of components 121, 151-152, and 161-168. Diagnostic report 152 contains telemetry that characterizes past or recent performance of database 110, including scalar measurements, some of which may be failure indications 167-168. For example, a scalar measurement may be a count of kilobytes accessed. Failure indication 167 may be a quantity such as a downtime duration or an error count, or may be a Boolean that indicates a threshold for that quantity is exceeded.

In an embodiment, the infrastructure of database 110 autonomously or on demand or as scheduled can automatically generate diagnostic report 152. For example, diagnostic report 152 may be encoded as XML, JSON, hypertext markup language (HTML), XML HTML (XHTML), or a document format such as document XML (docx) or portable document format (PDF), and computer 100 can parse diagnostic report 152 to extract scalar measurements and failure indications 167-168 for inspection by textual rules 141-144. Diagnostics report 152 may contain database diagnostics from health monitoring, diagnostic logs, persistent and network storage statistics, database performance statistics, and operating system (OS) statistics.

In various examples, failure indication 167 indicates a failure of an automated check of a condition such as security of the database, completeness of automatically generated diagnostic report 152, or validity of a checksum of a disk block in the database. In various examples, failure indication 167 indicates a failure of an automated check of the integrity of a data structure in database 110 such as column contents or a relational index.

In various examples, failure indication 167 indicates an expiration as an indication of a failure of an automated check of a recency of an updateable artifact such as a software version of a database server that hosts database 110, a firmware version of a storage server that persists the contents of database 110, or a firmware version of a remote direct memory access (RDMA) switch that interconnects multiple database servers that host replicas of database 110.

### 1.5 Interactively Completed Questionnaire

Interactive questionnaire 151 contains declarative indications 161-166 that are user-provided scalar values which are objectives, constraints, and relative priorities that database 110 should satisfy. For example, declarative indication 162 may indicate that the primary use of database 110 is either online analytical processing (OLAP) or online transaction processing (OLTP). In various examples, declarative indication 162 may indicate: a) whether database 110 will be accessed by client processing of bytecode or a scripting language, b) whether database 110 will have a standby and whether the primary purpose of the standby is recovery or availability, and c) whether database 110 will have a symmetric or asymmetric standby.

In an embodiment, declarative indication 162 may specify an operational activity, such as a prescribed best practice, that preserves or increases RAS performance of database 110. For example, declarative indication 162 may specify: a) a frequency of a maintenance activity such as database compaction, b) a frequency of diagnostic testing such as a system health check, or c) a count or recency of software patches that are deferred (i.e. not yet applied). Here, a prescribed best practice is proactive way to increase RAS performance of database 110. For example, an estimated RAS measurement (e.g. mean time between failures, MTBF) is positively correlated with health check frequency. For example, textual configurations 131-132 may respectively specify monthly and daily health checks that may cause scalar performance estimates 131-132 to respectively be lower and higher MTBF estimates.

Herein, a service level objective (SLO) may be any RAS performance indicator of a database or cloud, and a service level agreement (SLA) is a composite of multiple distinct SLOs. In one example, service level objective 161 may be a quality of service (QOS) metric such as one hour of downtime per month or a categorical (i.e. non-numeric) level of service such as no data loss. In various examples, service level objective 161 is a QoS metric such as network latency, network bandwidth, a ratio (e.g. percent) of uptime, a ratio (e.g. percent) of degraded (i.e. asymmetric) capacity after failover, a recovery time objective (RTO), and a recovery point objective (RPO). In any case and by definition, a service level objective entails a measurement (or an estimation of a measurement). Techniques for numeric aggregation of software-as-a-service (SaaS) performance measurements and quantities such as service level objective (SLO), service level agreement (SLA), quality of service (QOS), and key performance indicator (KPI) are presented in “Towards Measuring the Degree of Fulfillment of Service Level Agreements” published in year 2010 by Frank Schulz in Third International Conference on Information and Computing. Vol. 3. IEEE, which is incorporated in its entirety herein.

Numeric weights 164-166 are coefficients, multipliers, or ranks that are relative priorities of respective objectives. For example, comparison of two weights 164-165 may reveal that no data loss is more important than downtime or twice as important as downtime. In an embodiment, if weight 165 is zero, then downtime is a least important objective. In various examples, weights 164-166 each indicates a relative severity of a respective technologic problem that is a potential problem that might occur such as a hardware failure, a network outage, a database outage, and a loss of data.

In various embodiments, interactive questionnaire 151 may be encoded as XML, JSON, HTML, XHTML, docx, or PDF, and computer 100 can parse interactive questionnaire 151 to extract declarative indications 161-166 as scalar values for inspection by textual rules 141-144. For example, textual rules 142 may analyze scalar performance estimate 131 to detect that textual configuration 121 is unlikely to satisfy service level objective 161.

### 1.6 Structural Dynamism of Questionnaire

In an embodiment, a user may use a web browser or word processor to interactively insert values into interactive questionnaire 151. For example, editing of interactive questionnaire 151 may entail interactive entry of text and numbers into text entry fields and interactive manipulation of graphical widgets for data entry such as a checkbox, a radio button, a drop-down list, or a numeric spinner. In an embodiment, interactive questionnaire 151 is fully or partially prepopulated based on a current or earlier textual configuration of database 110 or a different database. For example, interactive questionnaire 151 may initially be a copy of a questionnaire of a different database.

In an embodiment, the structure of interactive questionnaire 151 is initially based on the pre-population of interactive questionnaire 151. For example, a section of interactive questionnaire 151 may be omitted (i.e. excluded) if a checkbox is initially unchecked. In an embodiment, the structure of interactive questionnaire 151 is dynamically adjusted when the data in interactive questionnaire 151 is interactively edited. For example, interactively toggling a checkbox may cause a section of interactive questionnaire 151 to be dynamically omitted or included.

### 1.7 Multiple Predefined Reference Architectures

Each of reference architectures 171-172 is a predefined set of values for a reusable portion of a textual configuration, and that portion can be copied into textual configurations of many databases. For example, reference architecture 172 may consume more computer resources and have better RAS performance than reference architecture 171. In various embodiments, reference architectures 171-172 are persisted as respective sets of records in database tables or as text documents in text files.

In one example, a condition of a particular rule of textual rules 142 detects that textual configuration 121 is unlikely to satisfy service level objective 161. The particular rule may: a) detect that service level objective 161 does not exceed service level objective 160 in reference architecture 172 and b) responsively select reference architecture 172 to satisfy service level objective 161, and this selection may cause textual rules 143 to make an exact or adjusted copy of reference architecture 172 and insert the copy into textual configuration 122. In an embodiment, textual rules 143 may insert an identifier of reference architecture 172 into textual configuration 122 even though textual configuration 121 instead contains an identifier of reference architecture 171 or does not identify any reference architecture.

In an embodiment that lacks reference architectures, textual rules 142 operate as discussed herein but without selecting a reference architecture, and textual rules 143 operate as discussed herein but without copying data from a reference architecture. In any embodiment, textual rules 142 analyze components 121 and 131 and write variables that cause textual rules 143 to generate textual configuration 122 as discussed herein.

### 1.8 Outage/Repair Matrix

Computer 100 generates report 180 that contains a representation of one, some, or all of components 121-122 and 131-132. Report 180 may be presented to the user for various purposes such as: a) an explanation of why textual configuration 121 is incomplete, infeasible, or suboptimal, b) an explanation of why textual configuration 122 is better than textual configuration 121, or c) a recommendation or plan to configure database 110 as specified by textual configuration 122.

Report 180 may be encoded as any of XML, JSON, HTML, XHTML, docx, or PDF. Although not shown, computer 100 may have textual rules that generate report 180. Report 180 may be presented to the user in a web browser, a word processor, an email, a spreadsheet, or a file.

Report 180 may contain multiple recommended adjustments that correspond to differences between textual configurations 121-122. For example, a recommended adjustment may be an increase of a computer resource such as additional processor cores or additional capacity of disk or memory. Each of urgencies 181-182 may indicate a relative priority or a due date of respective subsets of adjustment(s). In an embodiment, adjustments are visually sorted or colored in report 180 to indicate urgencies 181-182. In an embodiment, report 180 contains an outage/repair matrix in which each subset of adjustments is recommended as a way to prevent a recurrence of shown outage(s) that occurred. For example, report 180 may show duration and data loss of outages that already occurred while database 110 had textual configuration 121.

Rules 141-144 can be used speculatively to predict the reliability, availability, and serviceability (RAS) performance characteristics of an unimplemented configuration or used remedially to generate suggestions for improving RAS performance of a deployed configuration. In various scenarios with or without actually adjusting database 110, the user modifies textual configuration 121 based only on a more urgent subset of adjustments recommended in report 180 and without less urgent adjustments. In other words, the modified textual configuration may be a hybrid of textual configurations 121-122. The user can reevaluate textual rules 141 to generate a scalar performance estimate of the modified textual configuration. For example, the scalar performance estimate of the modified textual configuration may (e.g. numerically) fall between scalar performance estimates 131-132. If the user considers the scalar performance estimate of the modified textual configuration to be insufficient, the user may further modify the modified textual configuration with some more recommended adjustments until the user is satisfied with predicted scalar performance.

### 2.0 Example Plan Lifecycle

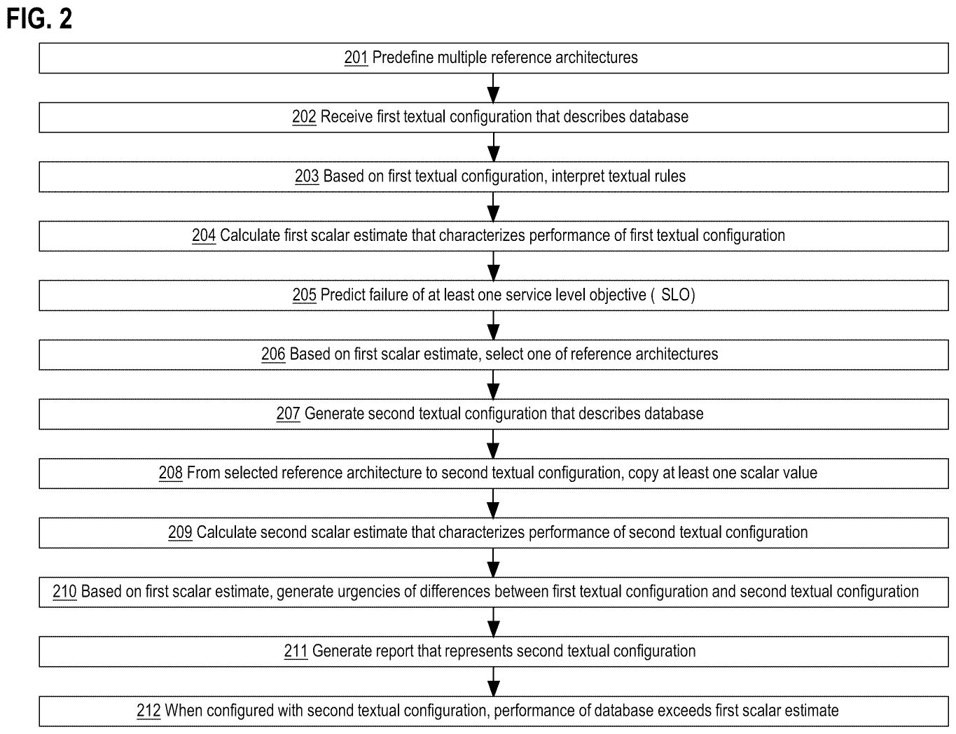

FIG. 2 is a flow diagram that depicts an example process that computer 100 may perform to interpret novel performance optimization rules to generate a configuration of a new database or an improved configuration of an existing database.

In various embodiments with or without reference architectures as discussed earlier herein, textual rules 142 analyze components 121 and 131 and write variables that cause textual rules 143 to generate textual configuration 122. Only if reference architectures are unused or unimplemented, steps 201, 206, and 208 do not occur or are unimplemented.

Step 201 predefines multiple reference architectures 171-172. For example, step 201 may occur before textual rules are developed. If computer 100 has a rules engine as discussed earlier herein, then textual rules 141-144 are loaded into the rules engine before step 202.

Step 202 receives textual configuration 121 that describes database 110. Textual configuration 121 may contain none, one, or both of components 151-152 as discussed earlier herein. For example, step 202 may receive textual configuration 121 as a file or a document. In an embodiment, if database 110 already exists, the infrastructure of database 110 automatically generates the whole or part of textual configuration 121, which is provided to step 202.

Based on textual configuration 121, step 203 interprets some or all of textual rules 141-144. For example, the rules engine may operate the rules during step 203, and this may entail evaluating conditions of rules and conditionally performing actions of rules as discussed earlier herein. Rule interpretation steps 204-211 are sub-steps of step 203 that interpret respective subsets of rules for particular purposes as follows.

In step 204, textual rules 141 calculate scalar performance estimate 131 that characterizes the reliability, availability, and serviceability (RAS) performance of textual configuration 121 as discussed earlier herein.

In step 205, textual rules 141 predict that a failure of at least one service level objective (SLO) 161 is likely. In an embodiment, step 205 estimates a failure probability that service level objective 161 will not be fulfilled and detects that the failure probability exceeds a threshold that is less than fifty percent. In an embodiment, textual configuration 121 allocates a quantity of a computer resource, such as RAM or processor cores or disk space, and step 205 predicts a failure of service level objective 161 by detecting that the quantity of the computer resource does not exceed a minimum amount. In an embodiment, the minimum amount is specified in reference architecture 172.

In an embodiment, step 205 predicts a failure of service level objective 161 by detecting that: a) service level objective 161 does not exceed service level objective 160 and b) textual configuration 121 is exceeded by reference architecture 172 for a specified resource capacity or a specified capability. For example, if step 205 detects that service level objectives 160-161 specify a recovery time of five minutes and that reference architecture 172 specifies a standby but textual configuration 121 does not specify a standby, then step 205 predicts a failure of service level objective 161.

In step 206, based on scalar performance estimate 131, textual rules 142 select one of reference architectures 171-172 as discussed earlier herein. In step 207, textual rules 143 generate textual configuration 122 that is better than textual configuration 121 as discussed elsewhere herein. Rule interpretation step 208 is a sub-step of step 207.

In step 208, textual rules 143 copy at least one scalar value from reference architecture 172, as selected by step 206, to textual configuration 122. For example, step 208 may copy a number that is a specified quantity of a computer resource or capacity such as a fraction of a rack, a size limit of a redo log, and a count of datacenters. In another example, step 208 copies a Boolean that specifies enabling or disabling a capability such as zero data loss. An example scalar value may be an indication of elasticity.

Between steps 208-209 in an embodiment, textual configuration 122 is error checked for validity. For example, two settings in textual configuration 122 may be independently valid but not in combination. In an embodiment, additional textual rules check textual configuration 122 for errors and adjust textual configuration 122 as needed for validity.

In step 209, textual rules 144 calculate scalar performance estimate 132 that characterizes the RAS performance of textual configuration 122 as discussed earlier herein.

Based on scalar performance estimate 131 from earlier step 204, recommended adjustments that correspond to differences between textual configurations 121-122 are identified by step 210. Step 210 may also assign respective urgencies 181-182 of adjustments to facilitate prioritization of adjustments to database 110 as discussed earlier herein.

Step 211 generates report 180 that is based on and represents either or both of textual configurations 121-122. Within report 180, step 211 may specify the recommended adjustments and urgencies 181-182 as discussed earlier herein.

For example, the user may apply some or all of the recommended adjustments to partially or entirely configure database as specified in textual configuration 122 as discussed earlier herein. When configured with some or all of textual configuration 122, the RAS performance of database 110 exceeds scalar performance estimate 131 in step 212. For example, step 212 may empirically verify that service level objective 161 is fulfilled. In that way, textual configuration 122 and textual rules 141-143 that cooperate to generate textual configuration 122 improve the RAS performance of database 110 and the database computer that hosts database 110.

### 3.0 Example Textual Rules

The following are example textual rules that various embodiments may: a) interpret in a rules engine, b) transpile (i.e. cross compile) to a compiled general purpose programing language such as a high level language (HLL) such as C (++) or Java, c) compile to bytecode or machine instructions of an instruction set architecture (ISA), or d) use as a design specification for handcrafting custom logic of an HLL. That is, use of these example textual rules may or may not entail a rules engine.

In an embodiment, these three example textual rules may cooperate in sequence as follows. For example, these rules may operate in a processing pipeline that contains a sequence of stages, and each of these three rules operates in a distinct respective stage. Thus, the following example textual rules are referred to as rules 1-3 that cooperate as follows. Rules 1-3 are JavaScript.

Rule 1 dynamically selects a best predefined reference architecture as discussed earlier herein. Rule 2 identifies deficiencies of the current text configuration when compared to that selected predefined reference architecture. From the current configuration, rule 3 generates an improved configuration that remedies the identified deficiencies. For example, the generated improved configuration may combine parts of the current configuration and parts of the selected reference architecture.

### 3.1 Example Rule One

Example rule one operates as follows.

If the recommended MAA solution is “Bronze”, the rule engine will display the following user-friendly message: “uses the high availability capabilities included in Oracle Database Enterprise Edition. MAA Bronze defaults to the Oracle Database single-instance or multitenant architecture. Oracle Restart or Oracle Clusterware high availability capabilities are used to restart a failed instance, database server, or any relevant managed service. For logical corruptions such as human error, you can use Flashback operations to “rewind” the database to a specific point in time. In the worst-case scenario of a complete site outage, there is additional time required to restore and recover the system and database from backups which may result in hours or days of downtime.

If the recommended MAA solution is “Silver” the rule engine will display the following user-friendly message: “is built on the foundation of the MAA Bronze architecture, and adds Oracle Real Application Clusters (Oracle RAC) active-active clustering for minimal or zero downtime in the event of database instance or server failure, as well as zero database downtime for most common planned maintenance events.”

If the recommended MAA solution is “Gold” the rule engine will display the following user-friendly message: “provides you with four architecture patterns with standby databases using Oracle Data Guard or—highly recommended-Oracle Active Data Guard. The patterns vary from a single remote active standby with Fast Start Failover and HA Observer, to multiple standby database configurations including standby reader farms, and finally a far sync (across regions) zero data loss standby configuration.”

If the recommended MAA solution is “Platinum” the rule engine will display the following user-friendly message: “has the potential to provide zero downtime for outages and planned maintenance activities. MAA Platinum builds on MAA Gold by adding Oracle GoldenGate replication to eliminate downtime for migrations, application upgrades, and database upgrades. Each Oracle GoldenGate database is protected by a standby database to enable zero or near data loss in case of database, cluster, or site failure.”

The following is example rule 1.

let arch = maaApi.computeRecommendedMaaSolution($0); if (arch ==
“Bronze”) { result = “uses the high availability capabilities
included in Oracle Database Enterprise Edition. MAA Bronze
defaults to the Oracle Database single-instance or multitenant
architecture. Oracle Restart or Oracle Clusterware high
availability capabilities are used to restart a failed instance,
database server, or any relevant managed service. For logical
corruptions such as human error, you can use Flashback
operations to “rewind” the database to a specific point in time.
In the worst-case scenario of a complete site outage, there is
additional time required to restore and recover the system and
database from backups which may result in hours or days of
downtime.”}; if (arch == “Silver”) { result = “is built on the
foundation of the MAA Bronze architecture, and adds Oracle Real
Application Clusters (Oracle RAC) active-active clustering for
minimal or zero downtime in the event of database instance or
server failure, as well as zero database downtime for most
common planned maintenance events.”}; if (arch == “Gold”) {
result = “provides you with four architecture patterns with
standby databases using Oracle Data Guard or - highly
recommended - Oracle Active Data Guard. The patterns vary from a
single remote active standby with Fast Start Failover and HA
Observer, to multiple standby database configurations including
standby reader farms, and finally a far sync (across regions)
zero data loss standby configuration.”}; if (arch == “Platinum”)
{ result = “has the potential to provide zero downtime for
outages and planned maintenance activities. MAA Platinum builds
on MAA Gold by adding Oracle GoldenGate replication to eliminate
downtime for migrations, application upgrades, and database
upgrades. Each Oracle GoldenGate database is protected by a
standby database to enable zero or near data loss in case of
database, cluster, or site failure.”}; result;

### 3.2 Example Rule Two

Example rule two operates as follows. Rule two is assessing if the Service level objectives (SLOs) for the recommended architecture are met. It returns either Passed or Failed, by reading data from the questionnaire, as follows. If all required technologies for the recommended architecture are being used, and All the observed SLOs recorded by the customer are within the recommended ranges, the SLOS Met Arch is passed. Otherwise, it is failed. The following is example rule 2.

let result = false; //slos_met_arch if
(maaApi.computeMissingTechnologies($0).length == 0 &&
maaApi.isInsideRangeForRecommArch($0)) { //slos_met_ops_bp let q
= [“documentHAAndPerformance”, “performFaultInjection”
,“runHealthChecks”,“securityPractices”,“escalationManagementPrac
tices”, “realTimeMonitor”,
“changeControlPractices”,“capacityPlanning”,“awareOfMAAPractices
”]; let result = true; for (var i=0; i< q.length;i++){ if
(!$0.operationPractices[q[i]] || $0.operationPractices[q[i]] !=
“true”) { result = false; break; } } if (result) { if
($0.operationPractices.testSystem.exists == “true” &&
$0.operationPractices.testSystem.symmetricToProd == “true” &&
$0.operationPractices.testSystem.runHealthChecks == “true”) {
let arch = maaApi.computeRecommendedMaaSolution($0); if (arch ==
“Gold” || arch == “Platinum” ||
($0.operationPractices.standbySystem.exists == “true” &&
$0.operationPractices.standbySystem.symmetricToPrimary == “true”
&& $0.operationPractices.standbySystem.drTestPeriodically ==
“true”)) { result = true; } else { result = false; } } else {
result = false; } if (result) { //slos_met_conf_bp let dbs =
maaApi.getDatabaseList(engagementId); let collectionIds=[ ]; for
each (var db in dbs) { if (db.type = “production”) { for each
(var collection in db.collections) { if
(collection.type=“exachk”) {
collectionIds.push(collection.collectionId); } }; } } if
(collectionIds.length > 0) { tfaReqList =
maaApi.searchTfaRequest(collectionIds, [ ],
“exachkReport.failed,exachkReport.critical”); if
(tfaReqList.length > 0) { for(let i = 0; i < tfaReqList.length;
i++){ tfaResult = tfaReqList[i]; if
(tfaResult[“exachkReport.failed”] > 0 ||
tfaResult[“exachkReport.critical”] > 0) { result=false; break; }
} if (result) { tfaReqList =
maaApi.searchTfaRequest(collectionIds,
[“exachkReport.exachkOutputs.fileKey”, “exachk_summary”],
“exachkReport.exachkOutputs.jsonFileContent”); if
(tfaReqList.length > 0) { for(let i = 0; i < tfaReqList.length;
i++) { tfaResult = tfaReqList[i]; let output =
tfaResult[“exachkReport.exachkOutputs.jsonFileContent”]; let
json = JSON.parse(output); if (json[“Maximum Availability
Architecture (MAA) Scorecard”] && json[“Maximum Availability
Architecture (MAA) Scorecard”][“SOFTWARE MAINTENANCE BEST
PRACTICES”] && json[“Maximum Availability Architecture (MAA)
Scorecard”][“SOFTWARE MAINTENANCE BEST PRACTICES”].length > 0 &&
json[“Maximum Availability Architecture (MAA)
Scorecard”][“SOFTWARE MAINTENANCE BEST PRACTICES”][0] != “PASS”)
{ result = false; break; } } } else { result = false; } } } else
{result = false; } } }}} result? “” : “ not”;

### 3.3 Example Rule Three

Example rule three operates as follows. In the following pseudocode algorithm, “operational_details_id”= “op_sw_updates” is based on the following questions within the following example questionnaire.

### MAA Questionnaire: (Step 8 Software Updates/Upgrades)

Question 1) Frequency of Database/Infrastructure Software Updates
Question 2) Do you subscribe to MOS alerts on recommended software changes?

In steps 1-2 and sub-steps in the following pseudocode algorithm. “operational_details_status” will report either PASS or CRITICAL or WARN.

```
1) PASS: Q1) is “yearly” or less AND Q2) is “yes”
2) NON-PASS:
  2.1) CRITICAL: Q1) is greater than “yearly”
  2.2) WARN: Q1) is “yearly” or less AND Q2) is
“no”“operational_details_result” will report the Report Output
as follows: If “operational_details_status” = PASS, then
“Database/Infrastructure software updates are performed at least
once a year. MOS alerts on recommended software changes are
subscribed to.”
    If “operational_details_status” = CRITICAL, then
      ∘ If Q1 is greater than yearly and Q2 is No --> ”
      Database/Infrastructure software updates are not
      performed at least once a year. MOS alerts on
      recommended software changes are not subscribed to.”
      ∘ If Q1 is greater than yearly and Q2 is Yes -->
      “Database/ Infrastructure software updates are not
      performed at least once a year. MOS alerts on
      recommended software changes are subscribed to.”
    If “operational_details_status” = WARN, then -->
    “Database/Infrastructure software updates are performed at
    least once a year. MOS alerts on recommended software
    changes are not subscribed to.”The entire rule could be
    summarise per the latest data, e.g. based on the report
    output.Something such as: The Operation software updates
    will calculate the cyclicality of the
    Database/Infrastructure software updates, if these are
    performed at least once a year or not.
```

The following is example rule 3.

let
q1=$0.dbFrequency,q2=$0.subscribedToExadataMOSAlerts,result=“”,s
tatus=“”; if (q1!=“other” ||
(q1==“other”&&$0.dbFrequencyNumMonths<=12)){
if(q2==“true”){status=“PASS”;result=“Database/Infrastructure
software updates are performed at least once a year. MOS alerts
on recommended software changes are subscribed to.”;} else
{status=“WARN”;result=“Database/Infrastructure software updates
are performed at least once a year. MOS alerts on recommended
software changes are not subscribed to.”;} } else {
status=“CRITICAL”;
if(q2==“true”){result=“Database/Infrastructure software updates
are not performed at least once a year. MOS alerts on
recommended software changes are subscribed to.”;} else
{result=“Database/Infrastructure software updates are not
performed at least once a year. MOS alerts on recommended
software changes are not subscribed to.”;} }
op={“operational_details_id”:“op_sw_updates”,
“operational_details_rule_name”:“Operational Practice: Apply
Recommended Software Updates and Security Updates Periodically”,
“operational_details_result”:result,
“operational_details_status”:status}; op;

### 4.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

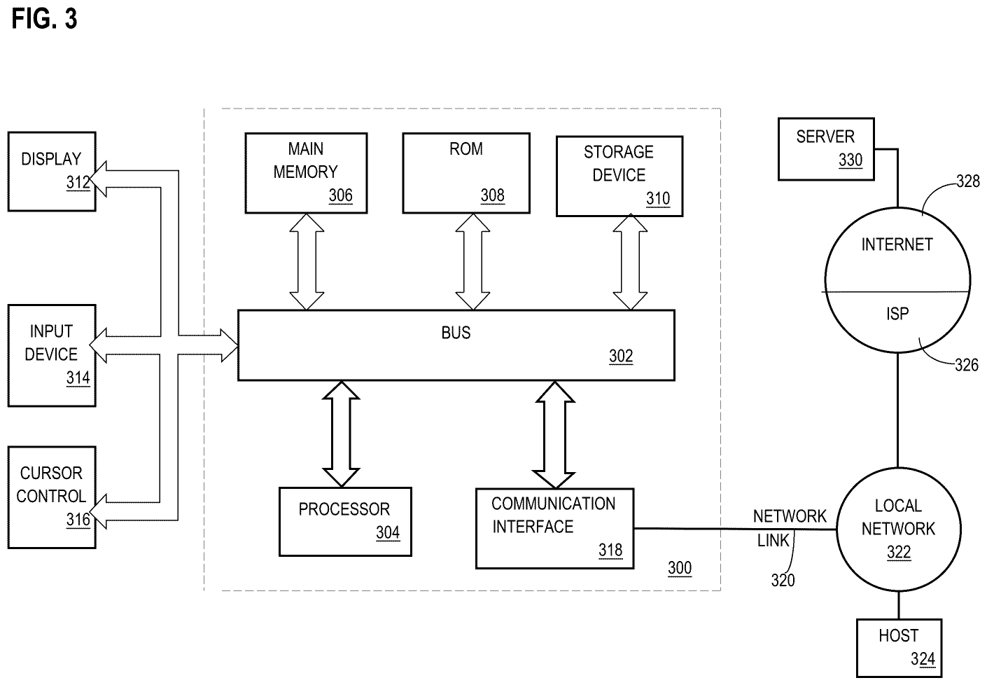

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

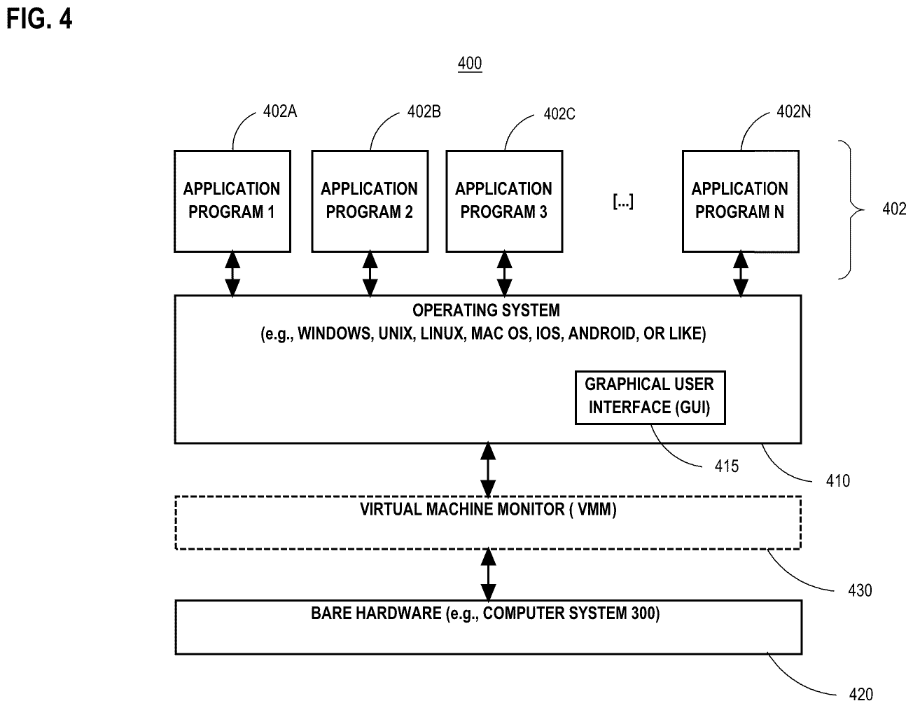

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 400 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments

of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving a first textual configuration that describes a database;
interpreting, based on the first textual configuration that describes the database, a plurality of textual rules to:
calculate a first scalar estimate that characterizes performance of the first textual configuration that describes the database,
generate a second textual configuration that describes the database, and
calculate a second scalar estimate that characterizes performance of the second textual configuration that describes the database, wherein the second scalar estimate exceeds the first scalar estimate;
generating a report that represents the second textual configuration that describes the database; and
configuring and operating the database with the second textual configuration to exceed the first scalar estimate;
wherein the method is performed by one or more computers.

2. The method of claim 1 wherein:
the method further comprises predefining a plurality of reference architectures;
the first textual configuration indicates none of the reference architectures;
said generate the second textual configuration comprises:
a) one of the textual rules selecting, based on the first scalar estimate that characterizes performance of the first textual configuration, one of the reference architectures, and
b) one or more of the textual rules generating, based on said one of the reference architectures, the second textual configuration;
the report that represents the second textual configuration indicates said one of the reference architectures.

3. The method of claim 2 further comprising one of the textual rules copying, from said one of the reference architectures to the second textual configuration, at least one scalar value selected from a group consisting of a fraction of a rack, an indication of elasticity, a size limit of a redo log, and a count of datacenters.

4. The method of claim 1 further comprising the textual rules generating the second textual configuration based on information from an interactive questionnaire comprising at least two weights that indicate a respective relative severity of a condition selected from a group consisting of: a hardware failure, a network outage, a database outage, and a loss of data.

5. The method of claim 4 wherein:
the method further comprises the textual rules generating, based on the first scalar estimate that characterizes performance of the first textual configuration, a plurality of urgencies of differences between the first textual configuration and the second textual configuration;
said generating the report that represents the second textual configuration comprises performing, based on said urgencies of differences, a formatting that includes coloring.

6. The method of claim 1 wherein:
the first textual configuration comprises information from an interactive questionnaire;
the second textual configuration does not comprise information from an interactive questionnaire;
the method further comprises the textual rules generating the second textual configuration based on the information from the interactive questionnaire comprising at least one declarative indication selected from a group consisting of:
an indication that the database will perform online analytical processing (OLAP) or online transaction processing (OLTP),
an indication that the database will be accessed by bytecode or a scripting language, an indication that the database will have an asymmetric standby, and
an indication that the database will have a standby whose purpose is recovery or availability.

7. The method of claim 1 wherein:
the first textual configuration comprises an automatically generated diagnostic report;
the second textual configuration does not comprise an automatically generated diagnostic report;
the method further comprises the textual rules generating the second textual configuration based on an indication, in the automatically generated diagnostic report, of a failure of an automated check of at least one condition selected from a group consisting of:
completeness of the automatically generated diagnostic report,
recency of a software version of a database server,
recency of a firmware version of a storage server,
recency of a firmware version of a remote direct memory access (RDMA) switch, validity of a checksum of a disk block in the database,
integrity of file metadata for the database,
integrity of column content in the database, and
integrity of a relational index in the database.

8. The method of claim 1 further comprising one of the textual rules predicting a failure of at least one service level objective (SLO) selected from a group consisting of:
network latency, network bandwidth, uptime ratio, degraded capacity ratio, recovery time objective (RTO), and recovery point objective (RPO).

9. The method of claim 1 wherein:
the database is a container database that contains a plurality of pluggable databases;
the method further comprises the textual rules calculating, based on a count of the pluggable databases, the first scalar estimate that characterizes performance of the first textual configuration.

10. The method of claim 1 wherein the first textual configuration consists essentially of information from an interactive questionnaire.

11. One or more non-transitory computer-readable media storing instructions that, when executed by one or more processors, cause:
receiving a first textual configuration that describes a database;
interpreting, based on the first textual configuration that describes the database, a plurality of textual rules to:
calculate a first scalar estimate that characterizes performance of the first textual configuration that describes the database,
generate a second textual configuration that describes the database, and
calculate a second scalar estimate that characterizes performance of the second textual configuration that describes the database, wherein the second scalar estimate exceeds the first scalar estimate;
generating a report that represents the second textual configuration that describes the database; and
configuring and operating the database with the second textual configuration to exceed the first scalar estimate.

12. The one or more non-transitory computer-readable media of claim 11 wherein:
the instructions further cause predefining a plurality of reference architectures;
the first textual configuration indicates none of the reference architectures;
said generate the second textual configuration comprises:
a) one of the textual rules selecting, based on the first scalar estimate that characterizes performance of the first textual configuration, one of the reference architectures, and
b) one or more of the textual rules generating, based on said one of the reference architectures, the second textual configuration;
the report that represents the second textual configuration indicates said one of the reference architectures.

13. The one or more non-transitory computer-readable media of claim 12 wherein the instructions further cause one of the textual rules copying, from said one of the reference architectures to the second textual configuration, at least one scalar value selected from a group consisting of a fraction of a rack, an indication of elasticity, a size limit of a redo log, and a count of datacenters.

14. The one or more non-transitory computer-readable media of claim 11 wherein the instructions further cause the textual rules generating the second textual configuration based on information from an interactive questionnaire comprising at least two weights that indicate a respective relative severity of a condition selected from a group consisting of: a hardware failure, a network outage, a database outage, and a loss of data.

15. The one or more non-transitory computer-readable media of claim 14 wherein:
the instructions further cause the textual rules generating, based on the first scalar estimate that characterizes performance of the first textual configuration, a plurality of urgencies of differences between the first textual configuration and the second textual configuration;
said generating the report that represents the second textual configuration comprises performing, based on said urgencies of differences, a formatting that includes coloring.

16. The one or more non-transitory computer-readable media of claim 11 wherein:
the first textual configuration comprises information from an interactive questionnaire;
the second textual configuration does not comprise information from an interactive questionnaire;
the instructions further cause the textual rules generating the second textual configuration based on the information from the interactive questionnaire comprising at least one declarative indication selected from a group consisting of:
an indication that the database will perform online analytical processing (OLAP) or online transaction processing (OLTP),
an indication that the database will be accessed by bytecode or a scripting language,
an indication that the database will have an asymmetric standby, and
an indication that the database will have a standby whose purpose is recovery or availability.

17. The one or more non-transitory computer-readable media of claim 11 wherein:
the first textual configuration comprises an automatically generated diagnostic report;
the second textual configuration does not comprise an automatically generated diagnostic report;
the instructions further cause the textual rules generating the second textual configuration based on an indication, in the automatically generated diagnostic report, of a failure of an automated check of at least one condition selected from a group consisting of:
completeness of the automatically generated diagnostic report,
recency of a software version of a database server,
recency of a firmware version of a storage server,
recency of a firmware version of a remote direct memory access (RDMA) switch, validity of a checksum of a disk block in the database,
integrity of file metadata for the database,
integrity of column content in the database, and
integrity of a relational index in the database.

18. The one or more non-transitory computer-readable media of claim 11 wherein the instructions further cause one of the textual rules predicting a failure of at least one service level objective (SLO) selected from a group consisting of: network latency, network bandwidth, uptime ratio, degraded capacity ratio, recovery time objective (RTO), and recovery point objective (RPO).

19. The one or more non-transitory computer-readable media of claim 11 wherein:
the database is a container database that contains a plurality of pluggable databases;
the instructions further cause the textual rules calculating, based on a count of the pluggable databases, the first scalar estimate that characterizes performance of the first textual configuration.

20. The one or more non-transitory computer-readable media of claim 11 wherein the first textual configuration consists essentially of information from an interactive questionnaire.
